(19) United States
(12) Patent Application Publication
(10) Pub. No.: US 2020/0319596 A1
(43) Pub. Date: Oct. 8, 2020

(54) DEVICE FOR COUPLING TWO HOROLOGICAL OSCILLATORS

(71) Applicant: Vianney Halter, Pontarlier (FR)

(72) Inventor: Vianney Halter, Pontarlier (FR)

(21) Appl. No.: 16/823,388

(22) Filed: Mar. 19, 2020

(30) Foreign Application Priority Data
Apr. 2, 2019 (FR) 1903503

(51) Int. Cl. G04B 17/06; G04B 15/14

(52) U.S. Cl. CPC G04B 17/06; G04B 15/14

(57) ABSTRACT

Horological device (100) comprising two oscillators (1a,b) with rotating and spiral (12a,b) balance wheels (11a,b), coupled for their synchronization. The oscillators (1a,b) are identical and their axles (22a,b) are parallel. The spirals (12a,b) are connected to a shared stud (13) by a link in the same direction but in the opposite direction, the stud being fixed to the rest of the horological movement.

### FIELD OF THE INVENTION

The present invention relates to a device for coupling two horological oscillators to ensure their synchronization.

### STATE OF THE TECHNIQUE

Since Huygens' observation in the 17th century of the synchronization of two clocks, many attempts have been made to reproduce and explain the phenomenon. Although we might clearly understand the phenomenon of synchronization applied to clocks today, the same phenomenon applied to spiral-balances is not.

The fundamental principle of horological mechanisms is the regulation of time division. To do this, times regulated by oscillators that are intended to be as isochronous as possible.

Isochronism is the ability of an oscillator to oscillate at its resonant frequency regardless of its amplitude.

In the case of a clock, the resonance frequency depends on the length of the clock axle. The clock is isochronous for small amplitude oscillations.

In 1675 Huygens found a way of reduction in volume and broke free of the clock spiral-balance.

In the case of a spiral-balance oscillator, the resonance frequency depends on the inertia of the balance, the stiffness of the spiral spring and the active length of that spiral. In practice, the isochronism of the spiral-balance is greatly affected by position, temperature, escapement, etc. and requires compensation.

The reason for synchronizing two spiral-balance oscillators is to compensate for their isochronism defects related to dynamic balancing. If the two components oscillate perfectly symmetrically, one of the oscillators compensates for all symmetrical dynamic imbalances of the other oscillator. A system with two symmetrically synchronized oscillators will have a better isochronism than the two oscillators taken separately.

The first attempt to achieve synchronization of spiral-balance oscillators was made in 1810 by Breguet in his two-movement watch. The balances were side by side and extremely close together. At present it is not known exactly how Breguet intended to achieve synchronization.

Recent developments in wristwatches have involved bringing the balance rims closer to the annular balance wheels to create a coupling via the layer of air closest to the balance wheels.

Although some of the more advanced wristwatch mechanisms currently manufactured have two oscillators designed to synchronize together, none of the proposed solutions is really effective in ensuring isochronism and its stabilization over time.

### Scope of the Invention

The present invention aims to develop a horological device comprising a group of two-by-two coupled spiral-balance oscillators allowing synchronization and improved isochronism to be achieved.

### Brief and Advantages of the Invention

For this purpose, this invention is aimed at a horological device composed of two oscillators with rotating and spiral balances, coupled together for their synchronization, this device being characterized in that the oscillators are identical and their axes parallel and the spirals are connected by their curved terminal to a shared stud attached to the rest of the horological movement.

This device according to the invention has the advantage of applying the difference in the forces exerted on the fixed shared stud. This difference is automatically established by the opposite mounting the terminal curves of the spirals on the shared stud. These studs are combined or associated in one piece to form the shared stud. This shared stud is connected to a fixed point in the movement.

The difference in the forces applied to the two curved terminals on the shared stud may correspond to tensile or thrust forces. This difference in forces has a direct effect on the stud, which in turn distributes it to the curved terminal curves of the spirals.

This direct transmission of the difference in forces equalizes the frequency of each oscillator very quickly, despite external and positioning disturbances.

According to another characteristic, the oscillators have either a flat or a Breguet spiral plane.

According to another characteristic, the shared stud is made of two integral studs, mounted head to tail, each receiving the end of the terminal curves of the two spirals. This allows direct transmission of the difference in the forces or pressures exerted by the spirals during their operation.

There is no functional difference between two studs combined with each other and a shared stud. The function is to generate a fixed point that joins one spiral to the other to achieve a balance of forces and thus the synchronization of the two oscillators.

Another advantageous feature is that the oscillators are arranged in such a way that the planes of the balances are parallel, their axes being in a common plane with the shared stud axis.

Another advantageous feature is that the two spirals are located inside the construction, between the two balances, so as to minimize the space between the spirals and maximize coupling efficiency. The escapes are therefore outside the space between the balances.

### BRIEF DESCRIPTION OF THE ILLUSTRATIONS

This invention will be described in greater detail below by means of the design methods represented in the attached drawings, in which:

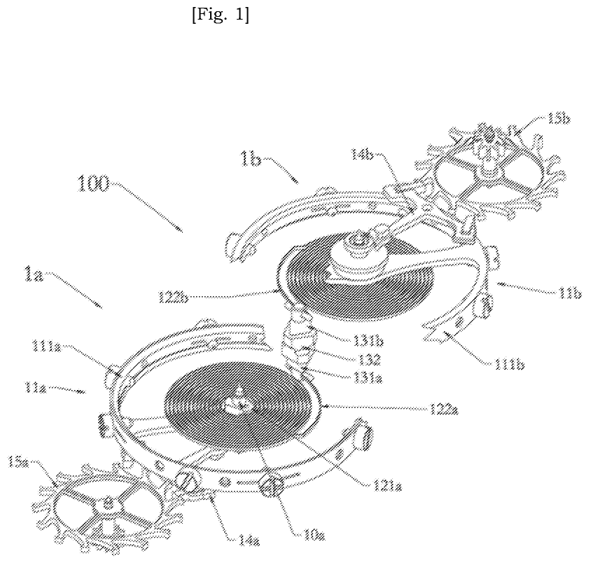

FIG. 1 is a perspective view of a first embodiment of a device with two oscillators with a rotary wheel balance oscillator and a spiral spring.

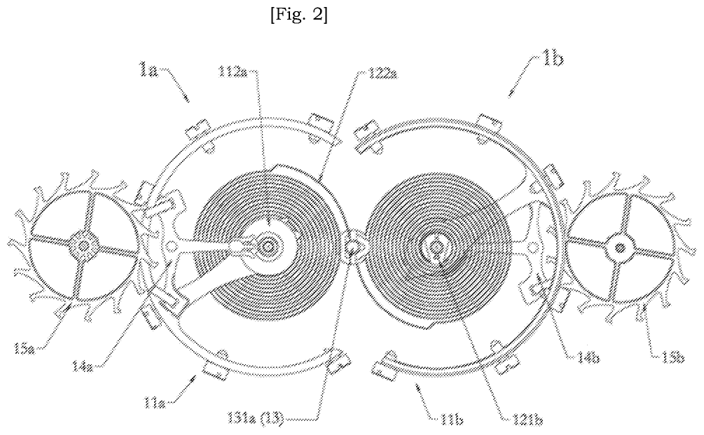

FIG. 2 is a bottom view of the device in FIG. 1

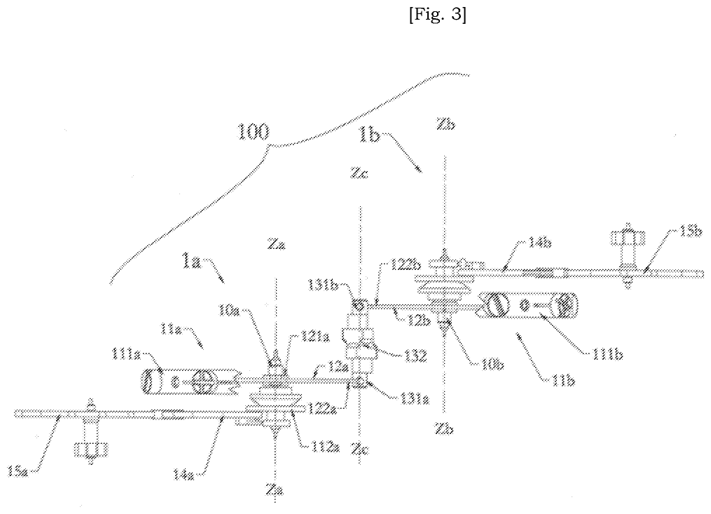

FIG. 3 is a sectional view of an axial plane of the device in FIG. 1

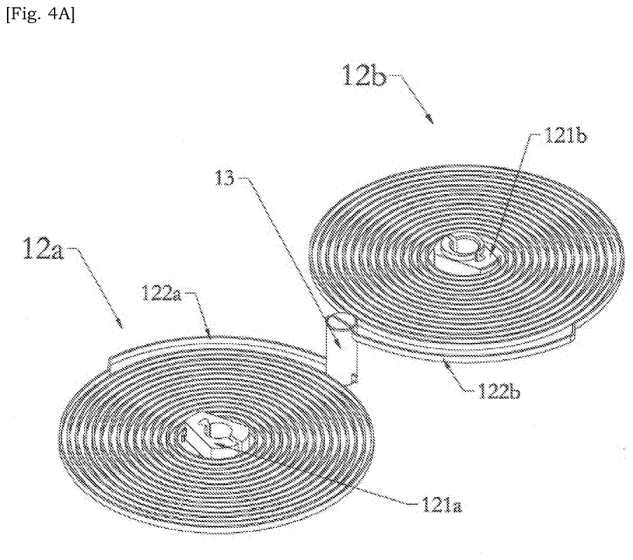

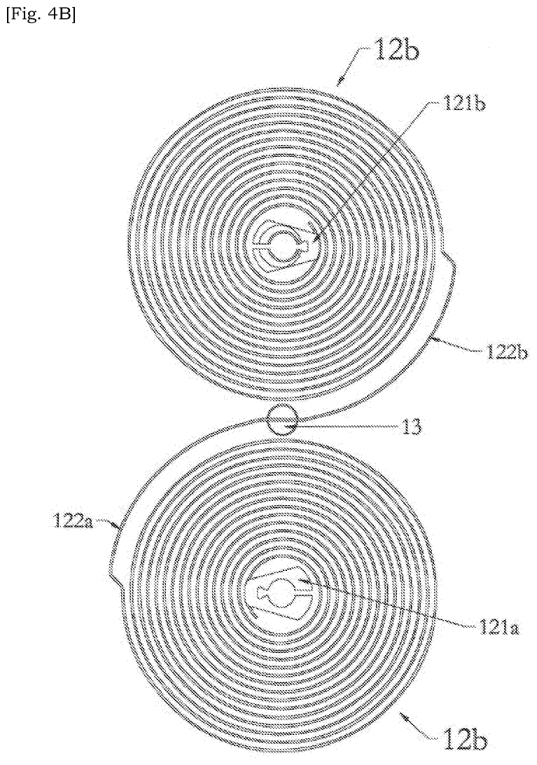

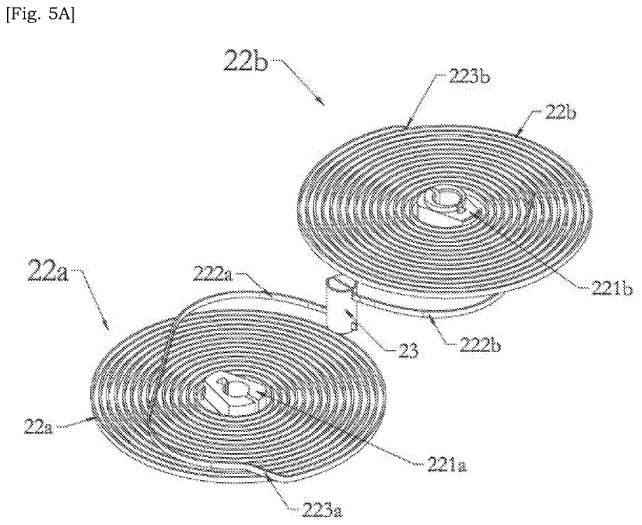

FIG. 4A is a detailed perspective view of the two spirals of the device in FIG. 1 attached to their shared stud.

FIG. 4B is a top view of the spirals and the shared stud of FIG. 4A.

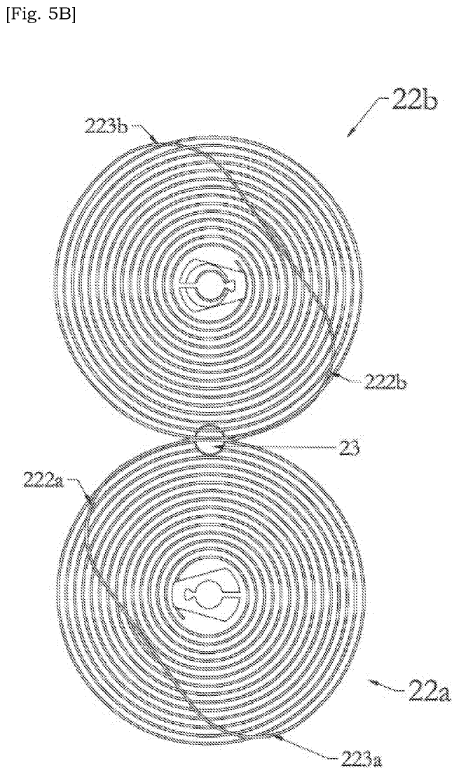

FIG. 5A is a perspective view of Breguet's spirals in another embodiment of the device in FIG. 1.

FIG. 5B is a plan view of the two Breguet spirals in FIG. 5A

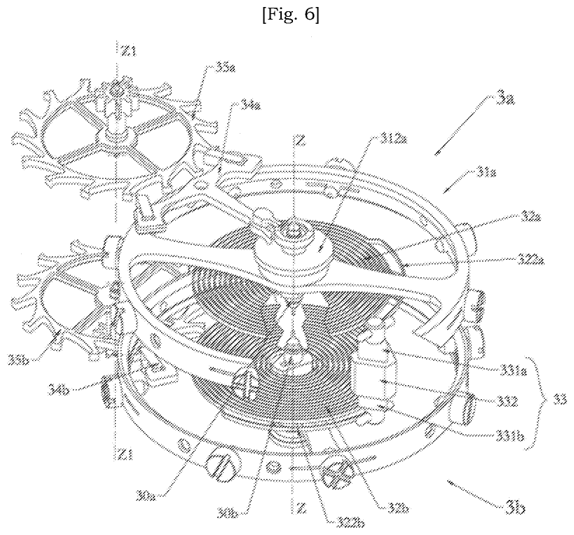

FIG. 6 is a perspective view of a third embodiment of a device with two coaxial oscillators.

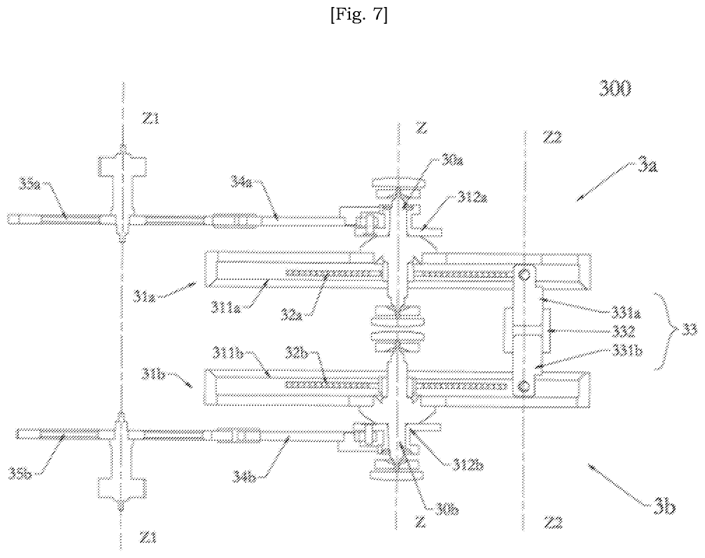

FIG. 7 is an axial sectional view of the device in FIG. 6.

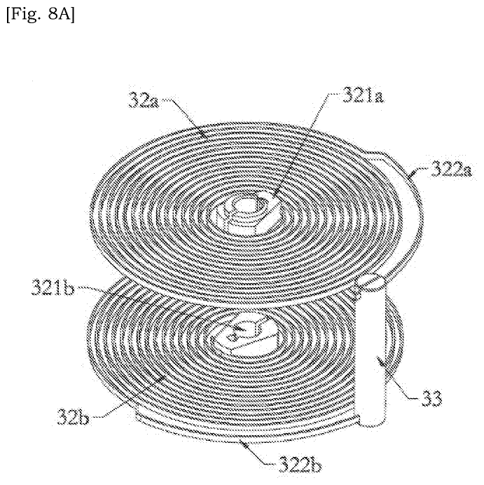

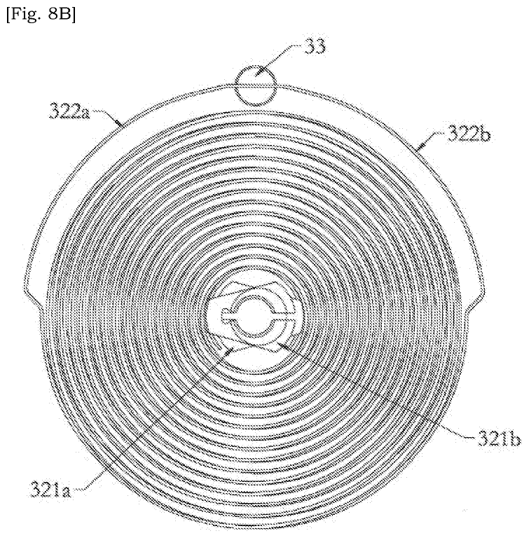

FIG. 8A is a perspective view of the two flat spirals in the device of FIG. 6.

FIG. 8B is a plan view of the two spirals in FIG. 8A.

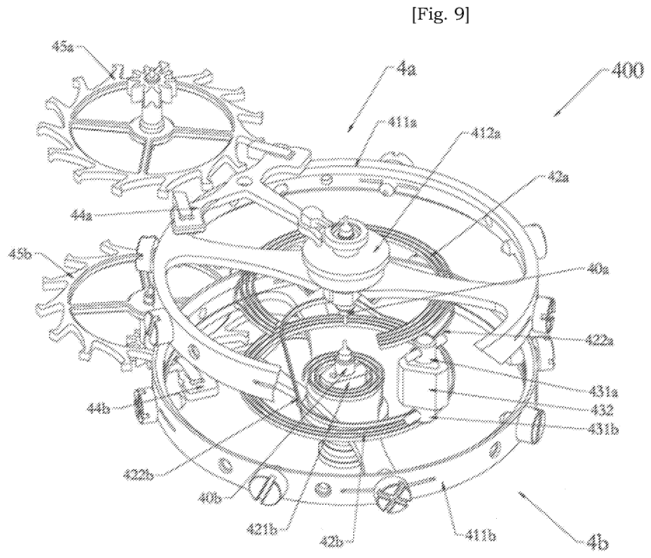

FIG. 9 shows a fourth embodiment of the device with two coaxial oscillators, seen in perspective.

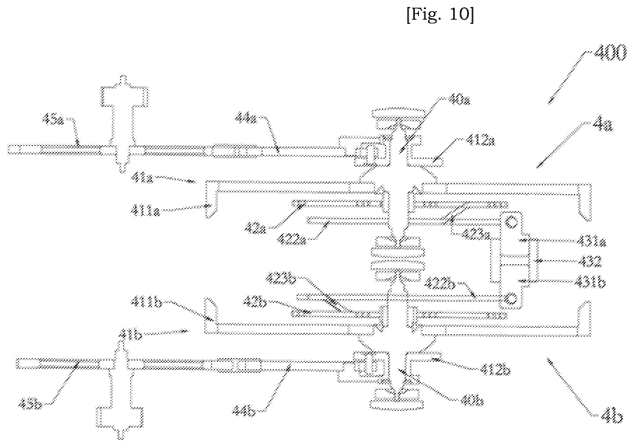

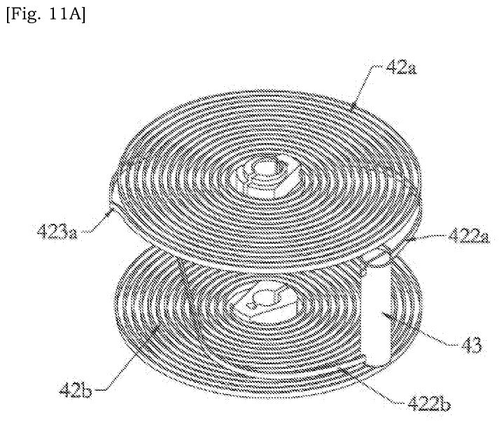

FIG. 10 is an axial sectional view of the device in FIG. 9.

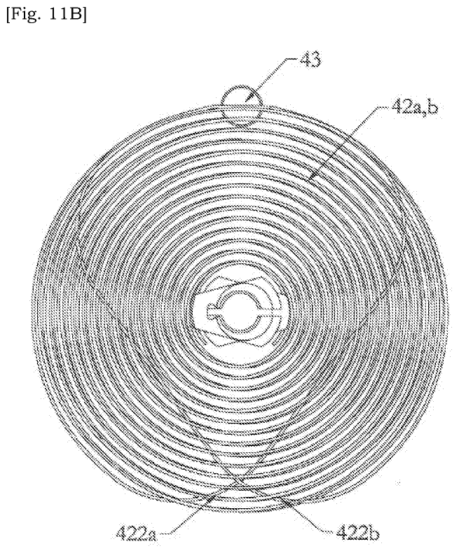

FIG. 11A is a perspective view of Breguet's spirals in a fourth embodiment of the device.

FIG. 11B is a plan view of the two coaxial Breguet spirals in FIG. 11A.

### DESCRIPTION OF AN EMBODIMENT

FIGS. 1, 2, 3 show a first method embodiment of the horological device 100. To simplify the presentation of the device, given the identity of the shapes and symmetries, one of the oscillators and its components will bear the numerical references supplemented by the suffix (a) and the other by the suffix (b). The representation is limited to the oscillators 1a,b, their anchor 14a,b and their escape wheel 15a,b which is connected to a gear train and mainspring not shown. The two oscillators 1a,b of device 100 are identical.

Each oscillator 1a,b consists of a balance wheel 11a,b with rim balance 111a,b and flat spiral 12a,b whose inner end is integral with a spiral collet 121a,b mounted on the axle 10a,b of the balance wheel 11a,b; its terminal curve 122a,b (i.e. its other end) is connected to a shared stud 13 integral with a non-detailed stud holder 132, itself fixed to the movement.

The conical portion of the balance wheel axle 10a,b which corresponds to the axle ZZa,b of the balance wheel 11a,b carries a double plateau 112a,b whose ellipse is in relation to the anchor 14a,b cooperating with the escape wheel 15a,b. This known part of the escape mechanism driving the oscillator 1a,b will not be described in more detail.

The two oscillators 1a,b are chiral, i.e. the balance wheel 11a and the spiral 12a and all their components are identical to the balance wheel 11b and the spiral 12b and all their components, to within the planar symmetry.

The axes (geometrical axes) ZZa,b of the two oscillators 1a,b are parallel. Both oscillators 1a,b are mounted so that they rotate in the same direction about their respective ZZa,b axis. This means that with respect to the same direction of the ZZa,b axes, both oscillators rotate in the same direction almost simultaneously. When the oscillators 1a,b are synchronized, they rotate in exactly the same direction at the same time.

The rotation of an oscillator 1a,b is the alternating movement of its balance wheel 11a,b driven by the anchor 14a,b in one direction and in the other, compressing then letting relax the spiral 12a,b.

The studs 131a,b to which the terminal curves 122a,b are connected are joined head to foot and for example joined together in a single piece called shared stud 13. The joining of the terminal curves 122a,b and the shared stud 13 is done in the same direction but in an opposite way so that the forces exerted by the spirals 12a,b on the shared stud 13 are opposite, i.e. the forces are aligned in the same direction but in opposite directions. Due to the symmetry of this mechanism, the direction of attachment of the ends of the terminal curves 122a,b to their studs 131a,b is in the plane not shown, perpendicular to the plane containing the ZZa,b axles and equidistant therefrom.

Oscillators 1a,b are in principle almost synchronous, so that the forces in the opposite direction applied to the shared stud 13 are of similar amplitude and opposite direction. The difference in amplitude of the forces due to their lack of synchronism is directly reflected from one terminal curve 122a,b to the other 122b,a via the shared stud 13 so that this difference decreases progressively until the oscillators 1a,b are synchronized.

The various parameters of the entire mechanism and external influences like gravity, the movements imparted to the mechanism and others, can disturb the oscillators which then resynchronize as described.

The average precision of a coupled balance wheel horological mechanism over a certain period of time improves as the synchronization or resynchronization is efficient and fast.

In more detail, the first embodiment of the device in FIGS. 1 to 3 comprises two oscillators 1a,b in parallel planes but offset in the direction of the axles ZZa,b to minimize the distance between the terminal curves of the two spirals. In this arrangement, according to the invention, the oscillators 1a,b are in a symmetrical plane with respect to each other. If we observe the mechanism along the axles ZZa,b the spirals 12a,b have the same winding, so that the spirals work in the same direction, so that the balance axles 11a,b rotate in the same direction at the same time. The same applies upstream for the escape wheels 15a,b and anchors 14a,b.

FIG. 2 shows in its bottom plan view, the interleaving of the volumes of the two oscillators 1a,b by the balance axle balance rims 111a,b. The balance rims 111a,b are shown partially cut to avoid complicating the drawing and for better perception of shared stud 13 and the opposite fastenings of the terminal curves 122a,b.

Since the two oscillators 1a,b are in separate planes one above the other, the balance rims 122a,b overlap as a projection but do not impede the movements of each other.

FIG. 3 is a simplified sectional view, without hatching, of the arrangement of FIGS. 1 and 2 showing the superposition of the two oscillators 1a,b and the intermediate arrangement of the shared stud 13. The axle ZZc of shared stud 13 is in the plane of the two axles ZZa,b of the oscillators 1a,b, parallel to and equidistant from the two axles ZZa,b.

FIGS. 4A,B show the spirals 12a,b of the two oscillators 1a,b and their shared stud 13 as well as the collet spirals 121a,b.

FIGS. 5A,B show another embodiment 200 of the mechanism with a device with two oscillators 2a,b like those 1a,b of FIG. 1 but with two Breguet spirals 22a,b. These spirals 22a,b differ from the flat spirals 12a,b of the first embodiment in that their terminal curve 222a,b is not in the plane of the spiral but in a parallel plane above this plane to join the shared stud 23. The terminal curve 222a,b joins this auxiliary plane by an inclined transition segment 223a,b.

The theoretical operation of this device is the same as that of device 100. All components that are identical to the previous ones are neither represented nor described.

The spirals 22a,b operate in the same direction by being, as in the embodiments of FIGS. 1 to 3, swiveled with respect to each other by 180° in their plane, if observation is along the axles ZZa,b; the terminal curves 222a,b passing respectively underneath and below the plane of their spiral 12a,b to reach their auxiliary plane and join the shared stud 23, in a median position between the two planes. This does not change the functional identity of the two spirals 22a,b and the oscillators 1a,b: the balance rims of the balance wheels turning in the same direction at the same time, just as the 22a,b spirals contract and expand at the same time.

The Breguet spirals 22a,b are brought together by comparison with the flat spirals; shared stud 23 is thus a plane projection, overlapped by the two spirals 22a,b.

FIGS. 6, 7, 8 A,B show an embodiment of device 300 in which the various components of device 300, identical to those of the previous embodiments, bear the same references as in FIGS. 1 to 3, where the first digit (3) replaces the digit (1).

The two oscillators 3a,b are coaxial on the ZZ axle. They comprise a balance wheel 31a,b, with rim balance 311a,b and flat spiral 32a,b, the inner end of which is integral with a spiral collet 321a,b mounted on the hub 30a,b of balance wheel 31a,b. Both oscillators and their escapes are geometrically identical.

Each terminal curve 322a,b is connected to a stud 331a,b. The two studs are head-to-tail and form a shared stud 33 connected to a 332a,b stud holder. The stud holder 332a,b is attached to the rest of the horological movement.

The two oscillators are arranged head-to-tail. If the system is viewed along the ZZ axle, the two spirals are wound in opposite directions.

In other words, the oscillators 3a,b are not symmetrical with respect to the mounting mid-plane, but antisymmetric since they rotate/oscillate in opposite directions.

The terminal curves 322a,b are connected to their studs 331a,b in the same direction but in the opposite way.

The two studs 331a,b form a shared stud 33 connected to a stud holder 332 whose connection with the rest of the mechanism is not shown.

In this assembly, as in the two previous assemblies, the compressive and tensile forces generated by the successive phases of compression and expansion of the spirals 32a,b are in the same direction but in opposite ways. The difference in the amplitudes of the forces applied to shared stud 33 is transmitted from one spiral to the other in order to gradually compensate for this difference in amplitude and achieve synchronization of the pair of oscillators.

The sectional view of FIG. 7 is in the shared plane containing the axles (ZZ), (Z1,Z1) and the axle (Z2,Z2) of shared stud 33.

This view shows the opposing arrangement of the two oscillators with respect to the median plane perpendicular to the (ZZ) axle (this plane is not shown). The terminal curve 322b in front of the intersecting plane is nor shown.

The dimensions of this device 300 in projection in the direction of axle (ZZ) are reduced since the escape wheels 35a,b are coaxial and their common axle (Z1Z1) is parallel to axle (ZZ).

The shared stud 33 has its axle (Z2Z2) located in the plane defined by axles (Z1Z1), (ZZ).

FIGS. 8A, 8B show in perspective and plan view the two flat spirals 32a,b and the terminal curves 322a,b connected to the shared stud 33 itself attached to the rest of the movement. These figures clearly show the operation in opposite directions of the two coaxial spirals 32a,b.

FIGS. 9, 10, 11B show a first method embodiment of the device 400. It differs from that of FIG. 6 in that the spirals 42a,b are Breguet spirals and not flat spirals. The other components are the same as before and their overall organization is identical so that all the elements identical or similar to those for example of the first embodiment according to FIGS. 1 to 3 bear the same references, the first digit (1) of which being replaced by the digit (4). The following description is limited to the differences related to the Breguet spiral 42a,b.

The antisymmetric coaxial arrangement of the oscillators 4a,b and the escape wheels 45a,b is retained.

A look along the ZZ axle reveals that the oscillators 4a,b with their balance wheel 41a,b and their spiral 42a,b rotate in opposite directions, generating forces in the same direction but in opposite directions applied to the shared stud 43. The difference in the amplitude of the forces is thus directly reflected from one spiral to the other by shared stud 43 to gradually achieve synchronization.

The terminal curves 422a,b of the Breguet spirals 42a,b leave the plane of their spiral to join another plane (auxiliary plane) parallel to the plane of their spiral. The sectional view in FIG. 10 shows more specifically the terminal curve 422a,b in the auxiliary plane above and below the spiral body to join the respective stud 431a,b (FIG. 10).

This arrangement is clearly shown in FIGS. 11A, 11B which show the single spirals connected to shared stud 43.

Thus the horological device according to the invention comprises two oscillators (1a,b) with rotating balance wheels (11a,b) and spiral balance wheels (12a,b), coupled for their synchronization and whose oscillators (1a,b) which are identical or identical to within a plane of symmetry, the axels (22a,b) of the oscillators 1a,b being parallel, the balance springs (12a,b) being connected by their terminal curves (122a,b) to a shared stud 13 by a connection in the same direction but in opposite ways and the shared stud (13) being fixed to the rest of the horological movement.

In this horological device the oscillators 1a,b comprise a plane spiral 11a,b or a Breguet spiral (21a,b).

The shared stud (13) comprises two studs (131a,b) which are joined together, mounted head-to-tail and each receiving the end of the terminal curves (122a,b) of a spiral (12a,b).

The oscillators (1a,b, 2a,b) are aligned in parallel planes, their axles (ZZa,b) being in a common plane with the axle (ZZc) of the shared stud (13), the escape wheels (15a,b) and the anchors (14a,b) being respectively above and below an oscillator (1a,b).

In this horological device the oscillators (3a,b, 4a,b) are superimposed in two parallel planes and the escape wheels (15a,b, 35a,b, 45a,b) are in planes parallel to those of the oscillators (3a,b, 4a,b), the axles of the escape wheels (15a,b, 35a,b, 45a,b) are coaxial and the shared stud (33, 43) is located between the two oscillators in the middle position.

### PARTS LIST OF MAIN COMPONENTS

### Without the Suffixes a and b

| | | | | |
|---|---|---|---|---|
| 400 | 300 | | 100 | Horological device |
| 4 | 3 | 2 | 1 | Oscillator |
| 40 | 30 | | 10 | Balance axle |
| 41 | 31 | | 11 | Balance wheel |
| 411 | 311 | | 111 | Balance rim |
| 412 | 312 | | 112 | Double plateau |
| 42 | 32 | 22 | 12 | Spiral |
| 421 | 321 | 221 | 121 | Spiral collet |
| 422 | 322 | 222 | 122 | Terminal curve |
| 43 | 33 | 23 | 13 | Shared stud/anchor |
| 431 | 331 | | 131 | Stud |
| 432 | 332 | | 132 | Stud holder |
| 44 | 34 | | 14 | Anchor |
| 45 | 35 | | 15 | Escape wheel |

To simplify the presentation of the claims, not all similar references are systematically included in the claims. They are shown only if necessary for understanding.

1. Horological device comprising two oscillators (1a,b) with rotating and spiral balance wheels (11a,b) (12a,b), coupled for their synchronization,
characterized in that
the oscillators (1a,b) are identical or identical to within a plane of symmetry
the axles (22a,b) of the two oscillators 1a,b are parallel
the spirals (12a,b) are connected by their terminal curve (122a,b) to a shared stud 13 by a connection in the same direction but in the opposite way.
the shared stud (13) is attached to the rest of the horological movement.

2. Horological device according to claim 1,
characterized in that
the oscillators 1a,b comprise a spiral plane 11a,b or a Breguet spiral (21a,b).

3. Horological device according to claim 1,
characterized in that
the shared stud (13) comprises two integral studs (131a,b), mounted head-to-tail and each receiving the end of the terminal curve (122a,b) of a spiral (12a,b).

4. Horological device according to claim 1,
characterized in that
the oscillators (1a,b, 2a,b) are aligned in parallel planes, their axles (ZZa,b) being in a common plane with the axle (ZZc) of the shared stud (13), the escape wheels (15a,b) and the anchors (14a,b) being respectively above and below an oscillator (1a,b).

5. Horological device according to claim 1,
characterized in that
the oscillators (3a,b, 4a,b) are superimposed in two parallel planes and
the escape wheels (15a,b, 35a,b, 45a,b) are in planes parallel to those of the oscillators (3a,b, 4a,b),
the axles of the escape wheels (15a,b, 35a,b, 45a,b) are coaxial and the shared stud (33, 43) is located between the two oscillators in the middle position.
